(19) United States
(12) Patent Application Publication
(10) Pub. No.: US 2008/0302460 A1
(43) Pub. Date: Dec. 11, 2008

(54) Method and system for manufacturing garments with support panels

(75) Inventors: Anthony Angelino, Edmond, OK (US); David Welsch, Livingston, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Cupid Foundations, Inc., New York, NY (US)

(21) Appl. No.: 11/811,171

(22) Filed: Jun. 7, 2007

(51) Int. Cl. B29C 65/00; A41C 3/00; A41D 1/00; A41D 7/00

(52) U.S. Cl. 156/60; 2/67; 2/69; 450/1

(57) ABSTRACT

A method for garment manufacture fixes a smaller panel to a larger piece of body fabric using adhesive to form a panel/body fabric assembly that provides at least one of smoothness, fit adjustability, support and/or control to the a garment. The adhesive is applied to a predetermined limited region of the panel. The adhesive is a thermosetting adhesive. After the adhesive is applied, the body fabric is assembled to the panel. A system of fixing the panel to the body fabric provides a coordinate surface that supports and places the body fabric and the panel in a fixed predetermined location. An adhesive dispenser is positioned relative to the coordinate surface by a controller based upon the coordinates of the panel on the coordinate surface. The dispenser then dispenses adhesive on the. The system aligns and assembles the body fabric to the panel to form the body fabric/panel assembly.

### BACKGROUND OF THE INVENTION

The present invention relates generally to garments that are required to have a form-fitting shape and methods for their manufacture. Garments have form-fitting shapes for a variety of reasons. One reason is to enhance or improve the appearance of the wearer. Such enhancement or improvement is accomplished by providing structure in the garment that provides the wearer with support in certain regions of the body that might otherwise bulge or sag in an unattractive or undesired manner. Such undesired bulging or sagging is referred to herein generally as a “figure flaw(s).” Garments with the proper support in the proper areas can mask such figure flaws either partially or completely, improving the appearance of the wearer.

Another reason that garments have a form-fitting shape is to flatter or emphasize the figure of the wearer. Even if the wearer does not have noticeable figure flaws, a garment that does not look attractive on the wearer will not be suitable to the wearer. Thus, even garments that are not intended to address figure flaws per se must have suitable support to ensure that they have an attractive appearance when worn. Form fitting garments that provide some support function for cosmetic purposes, often referred to as foundation garments, are referred to herein generally as “shape wear.”

In addition to support for cosmetic purposes, support is also required for functional purposes. For example, there is a particular need for support in any garment that will be worn during physical activity (e.g., swimming, running, cycling, climbing, etc.). Support is provided in such garments in a manner that allows for freedom of movement for the desired activity yet supports those regions of the body that require support during such activity. Such garments are referred to herein as “active wear.”

In active wear or shape wear, support is often provided by reinforcing certain regions of the garment with additional pieces of fabric. These pieces of fabric are referred to herein as fabric panels. The fabric to which the panels are affixed is referred to herein as the body fabric.

Panels have been affixed to body fabric in a variety of ways. In the most conventional and timeworn manner, panels are sewn to the body fabric. There are many disadvantages associated with sewing panels into a garment. First and foremost, sewing the panel onto the body fabric is labor intensive and/or equipment intensive. When fastening a panel to a body fabric, the stitching is required to be formed continuously on the perimeter of the panel. As such, the stitching must circumscribe the panel. This requires a complex stitching pattern that is difficult to precisely place relative to the panel perimeter. Specifically, it is difficult to consistently place the stitching at the panel perimeter. In those instances where the stitching is placed some distance from the panel edge (either further in from the panel edge or further out from the panel edge) the panel edge is not completely fastened to the body fabric, which allows the panel edge to bunch or bulge. Such bunching or bulging is not desired, especially in a form fitting garment. In active wear, the bulk of the panel stitching is undesirable because it can cause chafing or other discomfort to the wearer while engaging in sport or exercise. Such chafing or discomfort can be, at a minimum, distracting and can cause minor injuries under extreme circumstances.

Furthermore, such loose panel edges that occur when the panel is sewn to the body fabric can fray. Frayed edges can add bulk to the garment and can irritate the wearer. Furthermore, the thread used to sew the panel to the body fabric may be visible on the outer portion of the garment creating an unfinished or otherwise unattractive appearance. Also, in form-fitting or other garments where the body fabric has some degree of stretch, sewing the panel onto the body fabric can adversely restrict the fabric stretch.

But the problems of bunched or bulging panels or frayed panel edges are secondary to the problems of panel placement when sewing the panel to the body fabric. When sewing the panel to the body fabric, it is difficult to place the panel in a precise location with respect to the body fabric. As a consequence, one or more panel edges are often aligned with a seam of the garment to anchor the panel. While such alignment does allow for some precision in panel placement, the end result is often a bulky seam, given that the seam incorporates both body fabric and panel edges.

Other solutions for achieving precise placement of the panel relative to the body fabric during the sewing process also have drawbacks. In one solution, pins or pegs are used to align the panel with the body fabric during sewing. Sewing is mechanically intensive and can subject the panel to forces that can potentially cause the panel to move relative to the body fabric. In this solution the pins/pegs are used to retain the panel/body fabric alignment during the sewing process. However, this solution has certain drawbacks, chief among them being the holes in the body fabric caused by the pins/pegs. In another prior art solution, ultraviolet marks are made on the body fabric indicating the location where the panel is to be placed. In this solution, a black light is used to see the markings, which cannot be seen in normal light. While generally these marks are not visible on the garment under normal lighting conditions, it is preferred not to mark the fabric in any manner to ensure that such markings are never visible under any circumstances in a finished garment. Another problem with this solution is that it is difficult to automate, due to the visual nature of the process for placing the panel relative to the markings on the body fabric.

Other mechanisms for fastening panels to body fabric are known. Adhesives have been used to fasten panels to body fabric with mixed success. The success has been mixed because, oftentimes, the adhesive itself reduces the ability of the panel fabric, the portion of the body fabric to which the panel is attached, or both, to perform its intended function. For example, form fitting garments are often formed of fabrics with a certain amount of elasticity (i.e., stretch). Stretch can be engineered into fabric in a variety of ways. More rigid fibers provide a garment with little stretch. More elastic fibers provide for a garment with more give in the fabric. The weave of the fabric can also be selected to influence stretch. The fabric can be engineered to stretch in one direction (e.g., the “x” direction but not the “y” direction) or in both the “x” and “y” directions. Adhesive can fuse the fibers and interfere with the ability of those fibers to stretch in the way in which they were intended.

Precision placement of the panels onto the body fabric is equally problematic when adhesives are used to attach the panel to the body fabric. When using adhesives, additional problems from improper placement can arise if the adhesive affects the fabric stretch. This may make a region of the garment less flexible, which can adversely affect form, fit, function, or some combination thereof.

Consequently, there continues to be a need for economical, manufacturable solutions for attaching panels to body fabric, especially for shape wear and active wear in which form, fit and function are particularly critical.

### SUMMARY OF THE INVENTION

The present invention is applicable to many types of garments in which a first piece of fabric (panel hereinafter) is affixed to a second piece of fabric (body fabric hereinafter) to provide the garment with a desired characteristic. The desired characteristic can be, without limitation, associated with the support, comfort or fit that the garment provides to the wearer. More specifically, the body fabric has a certain intrinsic stretch characteristic. Once that fabric is selected, there is little the garment designer can do to the body fabric itself to influence its stretch characteristic. However, the designer can use a panel to work against the intrinsic stretch of the body fabric to build support, comfort or control into the body fabric. The designer can manipulate a variety of panel features to accomplish this objective. In addition to the stretch characteristic of the panel itself (which may be the same or different from the body fabric) the designer can use panel size, panel dimensions and panel placement to control the body fabric stretch in the desired manner. In addition to form, fit, and control, the present invention can be used to place panels of any configuration on a garment at any location, providing infinite flexibility for aesthetic design.

In one embodiment, a panel is added to the body fabric sides of a bra. The body fabric sides of the garment are attached to the bra cup. The panels reinforce the body fabric sides allowing them to stretch for the fit and comfort of the wearer, but sufficiently restrict the stretch of the body fabric sides to provide adequate support for the bra cup. One skilled in the art is aware of the different ways in which panels can be used to influence the stretch characteristics of the body fabric. The only underlying requirement is that the body fabric on which the panel is placed has some stretch. In this regard it is not required that the entire garment be formed of body fabric that stretches. It is contemplated that a garment be composed of more than one body fabric. One or more of these body fabrics will have a stretch characteristic and others may not. In these embodiments, the panel is only placed on the portion(s) of the garment having body fabric with a stretch characteristic. Due to the expense associated with adding panels to garments, designers will typically not add panels to body fabric that does not have at least some stretch characteristic.

In this regard, synthetic fibers (nylon, spandex) provide body fabric with some degree of stretch, while natural fibers (e.g. cotton, wool) typically do not. Synthetic fibers are described in detail below. Blends of natural and synthetic fibers (e.g. a spandex/cotton blend) provide some degree of stretch.

As such the garments with panels and the method of making garments with panels described herein finds particular advantage when used to make foundation garments, active wear, shape wear and the like type of garments (i.e., garments that are configured for fit, support and/or control). While the discussion of garments herein specifically references foundation garments and active wear, the present invention finds use in any type of garment. Foundation garments generally are garments worn underneath other garments (e.g. bras, girdles, etc.). Active wear is any garment engineered for wear during physical activity (e.g. cycling, running, swimming, etc.).

For convenience, the invention will be described in terms of a “panel” and a “body fabric.” However, this nomenclature is for convenience only. In certain embodiments the panel and body fabric will be made of the same material and are otherwise indistinguishable. However, due to the configuration and placement of the panel, the panel can restrict the stretch characteristics of the body fabric even if the panel and body fabric have the same stretch characteristics.

Specifically, adhesive is applied to predetermined regions of the first fabric (e.g. the panel) before it is affixed to the second fabric (e.g. body fabric). Again, for convenience, the first fabric to which the adhesive is applied is referred to as the panel and the other fabric to which the panel is attached is referred to as the body fabric. In all embodiments, the panel has an area no larger than the area of the body fabric. The adhesive is preferably in liquid form as applied, but the present also contemplates adhesives applied in film form. Liquid adhesive is dispensed onto the predetermined region using a nozzle or other dispensing mechanism (e.g. a roller) that is in fluid communication with a reservoir for the liquid adhesive. The liquid adhesive is dispensed through the opening in the nozzle or other dispensing mechanism and directed onto the panel in the predetermined region. Liquid adhesive is advantageous because it can be applied only where needed. Contrasting liquid adhesive to adhesive applied in film form and one skilled in the art will appreciate that liquid adhesive is susceptible to more targeted application. Adhesive binds to the fibers of the fabric and binds those fabrics with each other. Such binding will reduce the stretch of certain fabrics (particularly if the cured adhesive does not stretch, at least to the same degree as the fabric). Controlling/reducing the area of the fabric in contact with the adhesive, will preserve the stretch and flexibility of the fabric.

The predetermined region is a region that is proximate to the perimeter on the fabric panel. In a preferred embodiment, the predetermined region is substantially along the entire perimeter of the fabric panel. When adhesive is placed in the predetermined region that is substantially along the entire perimeter of the fabric panel, this ensures that adhesive is interposed between the panel and the body fabric substantially along the entire perimeter of the panel. Such an arrangement reduces the likelihood of spaces where there is no adhesive between the panel fabric and the body fabric. Such spaces are undesirable from both a mechanical and an aesthetic perspective. Mechanically, the gaps indicate that the seal and therefore the attachment of the panel to the fabric is less complete than it otherwise might be. Depending upon their extent, the spaces might allow the body fabric to give in the region of the space, therefore reducing or negating the panel support in the gap region.

Aesthetically, the gaps might permit the body fabric, the panel fabric or both, to bulge in the gap region. This is obviously undesirable from an appearance perspective, particularly in the context of form fitting garments, where bulges, puckers and anything that departs from a smooth appearance is to be avoided. Also, if the adhesive is not placed at the perimeter of the panel, then the panel itself potentially has a raw edge that can lend an unfinished appearance to the garment. Also loose fibers associated with the raw edge can cause discomfort to the wearer of the garment.

Although any conventional fabric is contemplated as suitable for the fabric panels or the body fabric, it is advantageous if both fabrics are made of synthetic materials. Examples of suitable fabrics include synthetic materials such as polyester, rayon, polyurethane foam, spandex (e.g., Lycra® a registered trademark of Invista Technologies S.A.R.L.), nylon and the like materials and natural fiber materials such as cotton and wool. As one skilled in the art is aware, fabric materials typically carry a finish material which gives a material a particular sheen and/or feel. One skilled in the art is aware that there are a vast number of finish compositions for fabrics. In the present invention, a fabric finish is selected that will not substantially degrade the adhesion between the adhesive and the fabric panel or the adhesive and the body fabric. One skilled in the art will be able to select an appropriate finish based upon the particular adhesive used. For example, if a water-based (i.e., hydrophilic) adhesive is used, hydrophobic (e.g., non polar) finishes should be avoided. Silicone-based finishes are examples of those finishes that should be avoided when a water-based adhesive is used. With certain adhesives, it may be advantageous to use unfinished fabrics if possible from an appearance/texture perspective.

Suitable adhesives are those that wet both the panel fabric and the body fabric (it is advantageous, but not required, that the panel fabric and the body fabric be made of the same material). The adhesive is applied onto the predetermined region of the fabric panel and placed into contact with the body fabric in an at least partially uncured state. It is advantageous if at least some pressure is applied when the fabric panel is placed into contact with the body fabric. It is advantageous if the pressure is at least about 8 to about 10 psi. Once placed in position relative to the body fabric, the adhesive is further cured.

As previously noted, it is required for at least one of the panel fabric and the body fabric to have some degree of elasticity. Preferably both the panel fabric and the body fabric have some degree of elasticity. This allows the garment to provide the desired shape, support, comfort, or some combination thereof to the wearer. In this regard it is advantageous, but not required, for the adhesive to stretch to some degree in its cured state. It is advantageous if the adhesive will elongate at least one hundred percent (i.e., can stretch to twice its length in its relaxed state). It is contemplated that the fabric panel or body fabric or both will stretch more than the adhesive in at least some embodiments.

That being said, one of the substantial advantages of the method and system described herein derives from the fact that the adhesive is only applied to a portion of the panel surface. Consequently, only a portion of the fabric fibers in the panel/body fabric assembly are in contact with the adhesive. It is appreciated that, even if the cured adhesive has elastic properties, it can still affect the manner in which the fabric stretches. The body fabric/panel assembly formed described herein exploits the advantages of an adhesive bond between body fabric and panel without allowing the adhesive to influence the stretch of the fabric fibers in the entire body/fabric panel assembly. In one embodiment it is advantageous if the predetermined region has an area that is less than fifty percent of the surface area of the panel.

Many different adhesives are contemplated as suitable for use in the present invention. In one embodiment of the present invention, thermosetting adhesives are used. As used herein, thermosetting adhesives are adhesives that cure when subjected to a thermal cycle of heating followed by cooling. Another characteristic of thermosetting adhesives is that, once cured, they cannot be remelted when heated.

In another embodiment of the present invention, thermoplastic adhesives are used. Thermoplastic adhesives, much like thermosetting adhesives, cure when subjected to a thermal cycle of heating and cooling. However, unlike thermosetting adhesives, thermoplastic adhesives can be remelted after cure.

Other adhesives that cure using mechanisms other than a thermal cure (e.g., ultraviolet radiation cure) are also contemplated as suitable for use in the present invention. Again, the requirements are suitable adhesion to fabric and maintaining adhesion and flexibility over time when subjected to repeated wear and washing.

In certain preferred embodiments, the garment is formed by applying to the fabric panel a heated, thermosetting adhesive in fluid form. One example of such an adhesive is a polyurethane adhesive (PUR adhesive) manufactured by the National Starch Co. It is advantageous if the adhesive contains additives that allow the contact regions between the adhesive and the panel and the adhesive and the body fabric to stretch along with the rest of the garment.

Although the adhesive, when introduced into contact with the fabric panel, wets the surface of the fabric panel, the amount of adhesive, the thickness of the adhesive and its viscosity are selected to ensure that the adhesive does not permeate through the entire thickness of the fabric panel. The reason for this is twofold. First, if the panel is in contact with the wearer, it is preferred that the adhesive used to affix the panel to the body fabric not be in contact with the wearer. Second, from an appearance perspective, adhesive permeating the panel fabric is not desirable. This is true when the panel is placed in either the interior of the garment or the exterior of the garment. In the present invention the panel is preferably placed in the interior of the garment.

Prior to cure, the panel with the adhesive deposited on a portion thereof is brought into contact with the body fabric. Not only is the panel brought into contact with the body fabric, but it is placed relative to the body fabric so that it provides the requisite function (fit, support or form) in the finished garment. Thus, the panel must not only be placed on the body fabric but placed in the appropriate location on the body fabric. In one embodiment, there is provided a panel handling system that controls the panel placement relative to the body fabric. With the panel so disposed, the panel handling system dispenses adhesive to the perimeter of the panel. Then, while maintaining this relative placement, the system brings the panel and body fabric into adhesive contact, ensuring proper placement of the panel on the body fabric.

In order to facilitate precision placement, a control system is required that can sense the placement of the panel relative to a reference position. The placement of the body fabric is similarly sensed. Since the panel has uncured adhesive thereon, a transfer mechanism that does not disturb the adhesive on the panel or bring the adhesive into contact with anything other than the body fabric to which the panel is adhered is preferred. In one embodiment a panel transfer table is employed that employs a releasable force to keep the panel in place on the table. In one example, that releasable force is vacuum suction on the backside of the transfer surface. The suction retains the panel on the surface as the surface bearing the body fabric is inverted, face side down, and brought into proximity with the panel. Once the panel is brought into contact with the body fabric, the force (e.g. vacuum) that holds the panel to the panel transfer table is released. The two surfaces are then separated, with the assembly of the panel fabric/body fabric being retained on the surface that supports the body fabric. The adhesive in the body fabric/panel assembly is then further cured to complete the fabric article.

Consequently, placement of the panel on the body fabric is accomplished without any reference to a feature of the body fabric (e.g. a seam) or without marking (e.g. using UV detectable ink) or otherwise damaging the body fabric or panel (by using alignment pins or pegs).

An apparatus for forming the garment is also contemplated. The apparatus includes a coordinate surface on which the panel of predetermined size is placed. The coordinate surface is operably connected with a moveable arm to which is attached a liquid adhesive dispenser. A controller is provided that moves the moveable arm and the liquid dispenser attached thereto. The controller is able to sense and control the movement of the moveable arm in the context of the coordinate space. In one embodiment, stepper motors and linear slide axis are provided for this purpose.

The coordinate surface is a reference surface. The surface coordinates correspond to coordinates programmed into the controller. An operator (or controller if the system is automated using software (e.g. Win/CNC Software which is commercially available from Microsystems of Buckhannon Inc. of Buckhannon W. Va.)) references the surface coordinates to precisely place both the panel and the body fabric on the coordinate surface. The controller controls the movement of the moveable arm relative to the coordinate surface. The coordinates of the predetermined region of the fabric panel (i.e., the region of the fabric panel proximate to the perimeter) is provided to the operator, the controller, or both, depending upon the extent of system automation. The controller selects coordinates for the moveable arm that correspond to the coordinates for the panel in the coordinate space. The controller then places the moveable arm and, by extension, the adhesive dispenser, proximate to the predetermined region. The controller then causes adhesive to dispense from the adhesive dispenser as the controller controls the movement of the moveable arm relative to the predetermined region.

Advantageously, the system provides precision control of the application of the adhesive in the predetermined region of the panel. The controller is programmable so that, for a given panel size and configuration, the moveable arm is controlled to provide adhesive onto the panel in the predetermined region. The controller is programmable to make this determination based upon the coordinates of the perimeter of the panel provided to the controller by either the operator or sensors provided on the coordinate surface. Specifically, the controller has an embedded algorithm, or is operably connected to a CPU or other component with digital processing capability. Based upon the input to the CPU, an algorithm, either in hardware or software, which is programmed to identify a predetermined region on which adhesive is placed based on panel dimensions, outputs the coordinates of the predetermined region to the controller. The controller then controls the movement of the moveable arm to dispense the adhesive in the predetermined region.

As noted above, the apparatus also assembles the panel, once adhesive is applied thereon, with the body fabric. In one embodiment, this transfer is accomplished by moving the coordinate surface on which the body fabric is placed proximate to the coordinate surface supporting the panel fabric. In one embodiment, the coordinate surface retains the panel and body fabric in place by drawing a vacuum from the back side. The vacuum is strong enough to retain the panel and body fabric on their respective coordinate surfaces as the coordinate surface bearing the body fabric is pivoted proximate to the coordinate surface bearing the panel, thereby bringing the body fabric into contact with the panel. The panel/body fabric assembly is then handled as a unit. Consequently, the vacuum force from one of the coordinate surfaces (either the panel coordinate surface or the body fabric coordinate surface) is turned off and the assembly is released to the other coordinate surface.

As noted above, the coordinate surfaces are equipped with features that provide for precision placement of the panel and body fabric on their respective surfaces. One skilled in the art is aware of many different mechanisms that facilitate precision placement of objects on coordinate surfaces. As such, not all such mechanisms are described herein. In one embodiment, the coordinate surface is a series of holes that are placed at specific coordinates (x,y) in the coordinate space. The holes are adapted to receive pins on the backside of pallets configured to support either the panel or the body fabric. The pallets and pins cooperated with the holes in the coordinate surface to place the panel and body fabric in a defined location within the coordinate space.

Therefore the operator can align the body fabric with the panel by selecting corresponding coordinates in the coordinate surfaces supporting the panel and body fabric respectively. In the embodiment where a sensor in the coordinate surface is employed, the coordinates of the holes in which the pallet pins are placed are transmitted to a CPU or other controlling mechanism. The transmitted coordinates are compared with the programmed coordinates to ensure that the body fabric and panel are placed on their respective coordinate surfaces in a manner that will ensure that the body fabric and panel will be properly aligned when brought into contact with one another.

The panel and body fabric are affixed by the adhesive and the application of some pressure. The amount of pressure is largely a matter of design choice. Pressures of about 8 psi or more are contemplated as suitable. As such, only light pressure is necessary to fix the body fabric to the panel. After the panel has been affixed to the body fabric, the adhesive is at least partially cured so that the panel will remain affixed to the body fabric during the subsequent processing required to produce the finished garment. In this regard, it is advantageous if the apparatus holds the body fabric and panel together when the panel/body fabric assembly is removed from the apparatus for subsequent processing. The apparatus optionally has a curing station that facilitates at least partial cure of the adhesive. The curing conditions depend upon the adhesive that is used. For example, thermosetting resins are heated to render them sufficiently viscous for application onto the panel. Generally, the adhesive is more viscous (i.e., has a greater resistance to flow) at lower temperatures. At lower temperatures, the adhesive is applied onto the panel with a greater bead thickness. Generally, a temperature is selected that will ensure a certain minimum degree of tackiness between the panel and the body fabric when the two are assembled.

Such adhesives are cured by subjecting them to cool, moist air. Thus, the curing section for an apparatus in which a thermosetting resin is used to assemble the panel to the body fabric will introduce cool, moist air proximate to the body fabric/panel assembly in order to at least partially cure the adhesive. It is advantageous if the panel/body fabric assembly is placed on a surface with a contour that somewhat mimics that of the finished garment. That is, a flat fabric assembly will be placed on a flat surface; a contoured fabric assembly will be placed on a surface with a complimentary contour. Placing the assembly on such a surface will prevent the assembly from bunching, pulling, etc., which could place the partially cured assembly under undue stress. Such stress could cause undesired imperfections in the fully cured assembly (e.g., gaps, irregular appearance, etc.). Curing on an appropriately contoured surface ensures that the assembly will not be subjected to undue mechanical stress during cure. Appropriate curing conditions depend upon a number of different factors among them being: 1) the temperature of the adhesive when applied to the panel; 2) the thickness of the bead of adhesive that is deposited to form the panel/body fabric assembly; 3) the amount of moisture in the air; 4) the temperature of the air; and 5) the volume of air circulating past the adhesive as it is cured.

### BRIEF DESCRIPTION OF THE DRAWINGS

The foregoing brief description, as well as further objects, features, and advantages of the present invention will be understood more completely from the following detailed description of presently preferred, but nonetheless illustrative embodiments in accordance with the present invention, with reference being had to the accompanying drawings in which:

FIG. 1 is a plan view of a panel affixed to a body fabric according to one embodiment of the present invention; with the predetermined region shown in phantom;

FIG. 2 is a flow chart of an exemplary process flow according to the present invention;

FIG. 3 is a perspective view of one embodiment of the system of the present invention that has first and second coordinate space surfaces in hinged attachment and the first coordinate surface supporting a pallet on which a fabric panel (not shown) is to be placed;

FIG. 4 is the perspective view of FIG. 3 but with the first coordinate space surface supporting a plurality of pallets;

FIG. 5 is a perspective view of one embodiment of the system of the present invention that has first and second coordinate space surfaces in hinged attachment with the coordinate space surface supporting the fabric panels substantially orthogonal to the second coordinate;

FIG. 6 is a perspective view of the system of FIG. 3, but with the second coordinate surface raised and supporting body fabric;

FIG. 7 is a bottom perspective view the system, illustrating the vacuum connection on the bottom side of the first and second coordinate surfaces;

FIG. 8 is a perspective view of the system with the glue dispenser stepper positioned to dispense glue onto a fabric panel;

FIG. 9 is a detail perspective view of FIG. 8, illustrating the dispensing of glue onto the fabric panel;

FIG. 10 is the system of FIG. 3 with the second coordinate surface folded over onto the first coordinate surface;

FIG. 11 is a side view of the system of FIG. 3 with the second coordinate surface folded over onto the first coordinate surface;

FIG. 12 is a detail view of FIG. 11;

FIG. 13 is a perspective view of the system of FIG. 3 after the fabric panels have been transferred onto the body fabric;

FIG. 14 is a perspective view of a panel pallet according to one embodiment of the present invention;

FIG. 15 is a perspective view of a body fabric support according to one embodiment of the present invention;

FIG. 16 is a top view of a panel pallet superposed on a body fabric support;

FIG. 17 is a perspective view of a panel pallet with alignment pins according to one embodiment of the present invention;

FIG. 18 is a bottom view of a body fabric support with alignment pins according to one embodiment of the present invention;

FIG. 19 is a plan view of the coordinate surface according to one embodiment of the present invention;

FIG. 20 is a plan view of the pallet placement in the coordinate surface, with exemplary coordinates illustrated;

FIG. 21 is a plan view of the pallet and platform placement in the coordinate surface, with exemplary coordinates illustrated;

FIG. 22 is a plan view of the pallet and platform placement in the coordinate surface using a cut out template;

FIG. 23 is a perspective view of the adhesive dispenser/coordinate surface assembly according to another embodiment that utilizes a roller coater to dispense adhesive;

FIG. 24 is a top down view of the assembly of FIG. 23, with adhesive partially dispensed on a panel supported by a pallet;

FIG. 25 is a front view of the roller coater adhesive dispenser;

FIG. 26 is a perspective view of the roller coater adhesive dispenser;

FIG. 27 is a detail view of the roller coated adhesive dispenser; and

FIG. 28 is a cut-away view of a portion of the roller coater mechanism of FIG. 27.

### DETAILED DESCRIPTION

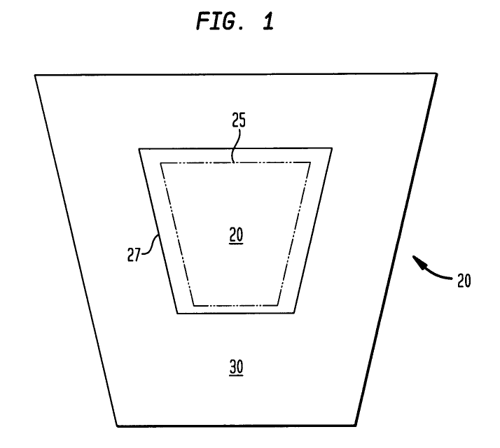

Referring to the drawings, FIG. 1 is a schematic representation of a panel/body fabric assembly 10 according to certain embodiments of the present invention. FIG. 1 illustrates a smaller fabric panel 20 on a larger body fabric 30. However, this is just an illustration. The panel can be the same size as the body fabric or significantly smaller. Although there is no absolute lower limit in the size of the panel to the body fabric, typically the panel will have a surface that is not less than about twenty percent of the surface area of the piece of body fabric on which the panel is placed.

It is important to note that a garment might be made from one or more than one pieces of body fabric. The embodiments of the present invention are described herein in terms of placing a panel on a piece of body fabric which may be directly formed into a garment or combined with other pieces of body fabric to form the garment. Moreover, as previously noted, the garment can be assembled from body fabrics made of different materials, some of which may have stretch characteristics and others which may not. In this embodiment only those portions of the garment made of body fabrics with stretch characteristics will potentially have panels placed thereon. The fabric panel 20 is preferably made of a synthetic material such as polyester, polyurethane, nylon, rayon, etc. The panel 20 is affixed to the body fabric 30 using adhesive 27 applied in predetermined region 25 (shown in phantom). The fabric panel, ultimately, is incorporated into a garment (not shown). As stated previously, the present invention finds use in manufacturing a variety of garments including, but not limited to, foundation garments and active wear.

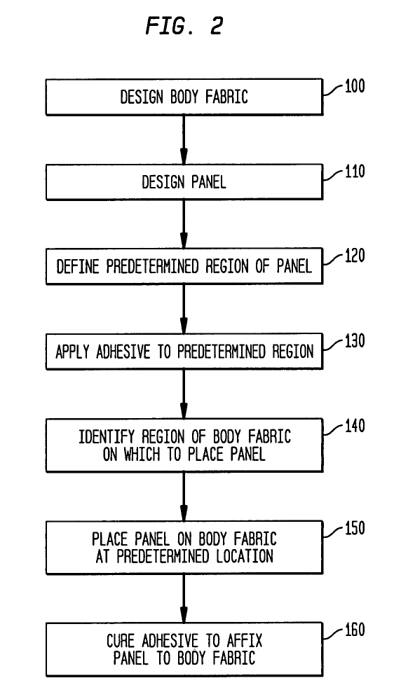

Referring to FIG. 2, there is a flow chart of one process flow of the present invention. Although the flow chart presents steps in a particular order, one skilled in the art will appreciate that the steps presented can be practiced in a different order.

Referring to step 100, the body fabric is designed. Designed, as used herein, encompasses numerous design concepts. One primary concept is the role played by the body fabric in the finished garment. This dictates the configuration of the body fabric as well as the placement of the panel on the body fabric. In the design step, the material of the body fabric is selected. One skilled in the art will appreciate that the selected material influences the overall design of the body fabric.

Referring to step 110, the fabric panel is designed. Since the panel cooperates with the body fabric to perform a desired function (shape, form or fit), the panel is not designed in isolation but with the body fabric in mind. For example, in certain embodiments, the body fabric will have some degree of stretch in one or both of the lateral and longitudinal directions. Depending upon the function of the panel, the panel might be designed to provide stretch in a direction complimentary to the direction of stretch of the body fabric or orthogonal to the direction of stretch of the body fabric.

Once the panel has been designed, the predetermined region of the panel is identified, according to step 120. The predetermined region is the region of the panel on which the adhesive will be applied. The predetermined region is determined by a number of factors, including, but not limited to, panel configuration, body fabric configuration, panel and body materials, and the function formed by the panel in the finished garment.

In one embodiment, the predetermined regions are determined algorithmically using discrete inputs. Exemplary inputs include, but are not limited to, panel dimensions, panel materials and panel elasticity. The properties of the body fabric also play a role in this determination, as the requisite adhesive surface area will vary depending upon the degree to which the adhesive adheres to the body fabric, the weight of the fabric and other factors. The properties of the adhesive itself are also considered. In this regard it is preferred if the flow rate at which the adhesive is dispensed onto the panel remains relatively constant for deposition along the entire panel perimeter. Variations in flow rate can cause variations in the consistency of the adhesive. These variations are not desirable, since the variations can cause the adhesion to be non-uniform about the perimeter of the panel. This in turn can adversely affect the adhesion between the panel and the body fabric or cause other adverse consequences such as non-uniform stretch.

Once the predetermined region is identified, the adhesive is applied to the predetermined region in step 130. One skilled in the art will appreciate that a number of different techniques can be used to apply the adhesive. In one embodiment, an automated process is used to deposit the adhesive. In this embodiment, microcontroller software (e.g. Win/CNC Software which is commercially available from Microsystems of Buckhannon Inc. of Buckhannon W. Va.) is programmed with the coordinates of the panel relative to the coordinate space. As such the microcontroller controls the application of the adhesive on the predetermined region of the panel. As described in detail herein, the panel and body fabric are placed in a coordinate space that corresponds to the programmed coordinates. This permits the controller to locate the panel on the coordinate surface, which also functions as a supporting surface, apply the adhesive onto the adhesive to the predetermined region, and transfer the panel to the right location on the body fabric. The coordinate surface will be described in detail later in the context of the illustrative embodiments. The software is also used to control the speed of the adhesive deposition.

It is advantageous if the fabric panel and body fabric are smooth before the adhesive is applied on the panel and the body fabric and panel are brought into contact. As such, it is advantageous if the adhesive bearing surface of the panel and the surface of the body fabric to which the panel is to be attached are substantially parallel at the time the panel and body fabric are brought together to form the body fabric/panel assembly.

The fabric panel 20 and body fabric 30 are typically finished fabrics, although the fabric panels can also be unfinished. Finished fabrics are well known to those skilled in the art. There are many fabric finishes, each providing a certain feel and appearance to a fabric. If finished, the fabric finish must be compatible with the adhesive that is used to form the body fabric/panel. In the context of the present invention, compatible means that the adhesive will adhere to the fabric with the finish thereon. One skilled in the art can readily ascertain how to select a finish that is suitable for use with a particular adhesive, and vice-versa. For example, if a water-based (i.e., hydrophilic/polar) adhesive is used, then the finish should not be hydrophobic or non-polar. Silicone-based finishes are examples of finishes that are not suitable for the body fabric or panel when a water-based adhesive is used to form the assembly. If a fabric has a finish to which the adhesive will not suitably adhere, the problem may be addressed by spray washing the fabric to remove or modify the finish. Finish properties can also be modified (e.g., the finish texture can be roughened) by subjecting the fabric to an electric field. One skilled in the art is well versed in the materials and conditions required to remove/modify a fabric finish, and, as such, they will not be discussed in detail herein.

The fabric panel 20 and body fabric 30 are illustrated as trapezoidal in FIG. 1, but one skilled in the art will appreciate that the panel and/or body fabric can be cut to any desired shape or size. One skilled in the art is aware of the many different techniques used to cut fabric panels for use in garment manufacture, which include both manual (e.g. scissor cutting) and automated techniques. Automated techniques include Gerber cutting, die cutting, sonic cutting, hydro cutting, and laser cutting.

The material and thickness of the fabric panels is largely a matter of design choice. While there is no requirement that the fabric panel and body fabric be the same material, there are certain constraints when different materials are used. One primary constraint is the shrinkage properties of the material. Since the panel and body fabric are brought together as one unitary article, both fabrics must have comparable shrinkage. If shrinkage properties of the two fabrics are significantly different, the disparity in shrinkage will cause the garment to bunch or stretch in response. Obviously, this is not a desirable result. Another constraint is the finish on the materials. While there is no requirement that the materials have the same finish, the finishes should permit a comparable degree of adhesion between both fabrics and the adhesive. In this regard, the panel should not have a hydrophilic finish when the body fabric has a hydrophobic finish, for example. Another constraint is thickness.

The thickness of the body fabric and panel fabric are a matter of design choice. Thicknesses will vary according to function. There is no requirement that the panel and body fabric have the same thickness. Examples of typical thicknesses for the fabric panel and body fabric are in the range of about 1 mil (a mil is 1/1000 of an inch) to about 7 mils thick.

The knit of the fabric panel is selected to prevent adhesive from penetrating through the thickness of the panel. As used herein, the knit is used to reference the manner in which the fibers are assembled to form the fabric. Reference to the fabrics as knitted is illustrative. Fabrics formed in any manner (e.g. woven fabrics) are contemplated as useful provided they have the specified characteristics. As previously noted, in certain embodiments the fabric panel rests on a pallet precision placed on a coordinate surface when the adhesive is applied thereto. Clearly, adhesive penetration onto this pallet surface is not desirable. In one embodiment, the pallet has a configuration that is similar to that of the panel. However, the pallet is configured such that the panel extends at least slightly beyond its perimeter of the pallet. This extension ensures that adhesive is not dispensed onto the pallet surface. Adhesive on the pallet surface could be transferred onto undesired locations on the body fabric during body fabric/panel assembly. Adhesive on the pallet surface could transfer onto the back surface of subsequent panels placed on that pallet, which is also undesired.

In another embodiment, the coordinate surface is a disposable covering over a supporting surface. The disposable coordinate surface has precision placed cut-outs where the pallets are to be placed. The precision placed cut outs are formed by using a precision cutting tool such as a Gerber cutting tool which is equipped with software for this purpose. After the adhesive is applied onto the panels and the panels transferred to the body fabric to form the panel/body fabric assembly, the disposable coordinate surface is removed. Any adhesive overspray onto the coordinate surface is removed with the coordinate surface. This reduces the need for the precautions taken to avoid adhesive overspray onto the coordinate surface.

The body fabric/panel assembly will be incorporated into the garment such that the panel, most typically, will be in the garment interior. Not being visible, appearance of the panel is not the most critical consideration in most embodiments. However, since the panel is in the interior of the garment, it is preferred if the adhesive does not penetrate the panel fabric because this results in adhesive being adjacent the skin of the wearer. This could result in skin irritation or other discomfort to the wearer and is to be avoided for these reasons.

In applications when the body fabric/panel assembly will be incorporated into active wear and foundations, the body fabric and the panel fabric typically will stretch at least somewhat in both the length and width directions. This is due to the function of the panel in the finished garment and is not a requirement of the present invention.

One skilled in the art is aware that the degree to which fabrics stretch is almost unlimited. Some fabrics have a material that provides for very little (i.e., almost zero percent) stretch. In the context of the present invention, the percent to which a fabric stretches is the difference in the dimension of the fabric in the direction of the stretching force compared to that dimension when the fabric is in its relaxed state (i.e., no stretching force applied) as a percent of the dimension of the fabric in its relaxed state. As one skilled in the art is aware, fabrics stretch up to two hundred (200) percent or even higher.

Thus, the garment can be formed using a fabric panel and body fabric with some degree of stretch (including very limited stretch, i.e. almost zero degrees). Certain considerations might inform the selection of a particular degree of stretch, chief among them being the function of the panel in the garment.

As noted above, many different adhesives are contemplated as suitable. The selected adhesive will adequately adhere to the panel/body fabric and the finishes on those fabrics. Furthermore the adhesive, once cured, must remain supple over time even through repeated wearings and washings of the garment. Examples of suitable adhesives include thermosetting adhesives and thermoplastic adhesives. One example of a thermoplastic adhesive is Griltex® co-polyester adhesive.

In one embodiment, it is advantageous if the adhesive contains a dye so that the adhesive at least somewhat matches the color of the fabric panel/body fabric. Dyes or other additives suitable for coloring adhesive are well known in the art and not described in detail herein. The color of the selected dye depends upon, for example, the color of the fabric panel and the body fabric and the degree of match between the adhesive and the fabric panel/material strip that is sought (if any). Also, the dye or other color additive must be chemically compatible with the adhesive. For example, if the adhesive is water-based, then the dye would also be water-based. Conversely, if the adhesive is hydrophobic, then the dye would also be hydrophobic.

A specific example of a thermosetting adhesive is the hot melt adhesive from National Starch and Chemical Company (Bridgewater, N.J.) sold under the name PUR-FECT LOK® 34-714A. In order to provide an adhesive with sufficient stretch when cured, additives can be included with the adhesive. One skilled in the art is aware of suitable additives for thermosetting adhesives that increase the stretch in the cured adhesive. In certain preferred embodiments, the adhesive is one that cures when cooled, and the cure is accelerated in a moist air environment.

In the embodiment of the present invention in which a thermosetting adhesive is used, the adhesive is heated in a container under pressure. An inert atmosphere is provided to pressurize the adhesive. In one embodiment, the inert atmosphere is an argon atmosphere. In another embodiment, the inert atmosphere is super-dried air. Nitrogen is yet another example of an inert atmosphere. In the context of dispensing adhesive, an inert atmosphere is one in which the adhesive does not substantially cure the adhesive. In another embodiment, the adhesive is stored under vacuum. These are but examples of apparatus used to store and deliver the adhesive to the system. One skilled in the art is aware of other mechanisms that can be used to deliver adhesive under conditions that do not expose the adhesive to the atmosphere prior to delivery (e.g. a piston driven pump).

The adhesive is dispensed either by pressure from the inert atmosphere alone, or by use of a mechanical pump. In the embodiment where the adhesive is stored under vacuum, the adhesive is dispensed from the container using a piston type mechanism. The adhesive material is dispensed in liquid form. In the embodiment where pressurized argon is used to dispense the adhesive, approximately five to fifteen pounds of argon pressure is all that is required to accomplish this objective. The material cures when cooled in ambient air and the cure is accelerated if the air is moist. The greater the amount of moisture in the air, the faster the cure. The preferred adhesive is a thick paste that is heated to be converted to a liquid form. The melting temperature will depend upon the particular adhesive used. Specifically an adhesive with a melting temperature that is less than the temperature that would adversely affect the fabric panel/body fabric is preferred. For example, if fabric panels will be adversely affected by temperatures higher than 350° F., adhesives with a melting temperature higher than about 350° F. should be avoided. Similarly, if the fabric can withstand temperatures of about 300° F. or less, then an adhesive with a melting temperature of less than about 300° F. should be used.

Adhesives that require temperatures of greater than about 340° F. to be in liquid form are less preferred because the synthetic materials used for the panel/body fabric might be damaged if placed into contact with a substance at such higher temperatures. Also, high temperatures are preferably avoided for operator safety. It is advantageous if the uncured adhesive melts at temperatures in the range of about 200° F. to about 280° F., and more preferably temperatures of about 200° F. to about 260° F. and is sufficiently liquid (i.e., have a viscosity that is sufficiently low) at these temperatures to facilitate application onto the panel. In this regard, adhesives with curing temperatures in the lower half of the aforesaid range have tackiness when the adhesive is applied to the panel that provides for advantageous handling of the assembled panel and body fabric prior to cure. In any event, overheating is to be avoided as it can cause the adhesive to discolor (e.g., turn yellow). This can cause a less than desirable appearance.

In this regard, it is also advantageous if the panel fabric and the body fabric are heated when assembled. Heating the body fabric and panel is optional. The optional heating step improves fabric handling somewhat. Also, heating the panel will improve the penetration of the adhesive into the panel fabric. Again the upper limit on temperature is the heat tolerance of the fabric itself. There is no need to heat the fabric to a temperature in excess of the melting temperature of the adhesive.

The adhesive is applied using any suitable mechanism. However, in order to meet the objectives of targeted placement and speed, a nozzle is preferred. Examples of suitable nozzles include both slot nozzles and spray nozzles. A slot nozzle provides a bead of adhesive and therefore permits the application of adhesive directly onto the predetermined region at a controlled thickness. A spray nozzle permits a large amount of adhesive to be applied quickly but the amount of “overspray” onto other surfaces is greater with a spray nozzle than with a slot nozzle. The nozzles can be used alone or in conjunction with other dispensing mechanisms. For example, the nozzle can direct adhesive onto a roller coater that can be used to uniformly apply the adhesive onto the panel.

Those skilled in the art will appreciate that adhesive may be applied by any other conventional method that will allow it to wet the panel in a targeted area. Application conditions (e.g., adhesive thickness) are controlled to prevent the adhesive from bleeding through the panel. For example, if the panel is about 7 mils thick, the adhesive is applied using conditions (e.g., thickness, viscosity, etc.) that limit the penetration of the adhesive into the panel to about 5 mils or less.

The preferred adhesive cures if exposed to an ambient atmosphere, but curing can be accelerated by exposing it to moist (i.e., humid) and/or cold air. One example of suitably moist air is ambient air with at least about forty percent humidity. In embodiments described in detail below, once the panel is in position on the body fabric, a stream of cool, moist air is directed at the fabric panel/body fabric assembly. This initiates curing of the adhesive and permits the fabric panel/body fabric assembly to be handled without separating the two pieces.

Referring to step 140, the body fabric is placed on a separate supporting surface. This separate supporting surface is a coordinate surface as previously described. The coordinate surface allows for precision placement of the body fabric. Precision placement ensures that the body fabric and panel are properly aligned when assembled together. The placement of the panel on the body fabric is critical in order to ensure that the panel performs the desired function in the garment. One skilled in the art will appreciate that the placement of the panel on the body fabric can be accomplished by a number of different mechanisms.

Once the body fabric and panel are properly placed on their respective coordinate surfaces, and the adhesive is deposited on the panel, the body fabric and panel are assembled. In one embodiment, the coordinate surface supporting the body fabric is inverted and brought into contact with the surface supporting the panel. The body fabric is kept in place on the supporting surface using a variety of mechanisms well understood to one skilled in the art. In one exemplary embodiment, a vacuum force is drawn from the backside of the supporting coordinate surface to hold the body fabric in place. The position of the coordinate surface bearing the body panels is controlled to ensure that it is properly aligned with the coordinate surface supporting the panels. Correct alignment will ensure that the panels are brought into contact with the body fabric at the proper location.

According to step 150, the panel is placed on the body fabric at the predetermined location. After the panel is fixed to the body fabric, the adhesive is cured according to step 160. The cure conditions depend upon the adhesive that is used. Typically, an environment which causes the adhesive to at least partially cure once the panel is placed into contact with the body fabric will be employed. A partial cure will ensure that the body fabric and panel do not separate in subsequent handling prior to the adhesive being fully cured.

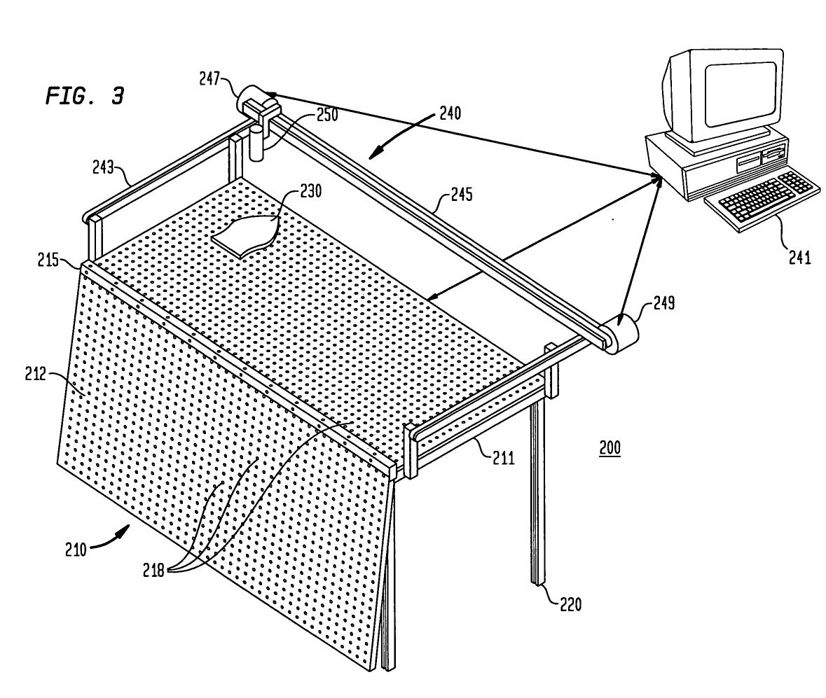

Referring now to FIG. 3, there is illustrated a system for affixing panels to body fabrics according to one embodiment of the present invention. According to the embodiment illustrated in FIG. 3, the system 200 has a supporting surface 210 that has a first coordinate surface 211 and a second coordinate surface 212. The first coordinate surface 211 supports pallets 230. The second coordinate surface 212 is in hinged connection with coordinate surface 211 via hinge 215. Surfaces 211 and 212 have apertures 218. These apertures allow for vacuum attachment of articles, such as perforated pallet 230, on the surfaces 211, 212. The apertures also set coordinates for precision placement of the body fabric and panel within the coordinate surface as described in detail below.

The system 200 is also equipped with a motorized positioner 240. This motorized positioner has two slides, one slide 243 for movement along the “y” axis and another slide 245 for movement along the “x” axis. The motorized positioner 240 also has stepper motors to allow for movement of adhesive dispensing head 250. Stepper motor 249 is provided to move the adhesive dispensing head along the “x” axis. Motorized positioner 240 also has another stepper motor 247 which moves the adhesive dispensing head 250 along the “y” axis. The system is equipped with a controller 241. Controller 241 is programmed with the software needed to control the slides 243 and 245 in response to coordinates in the software. In this regard the software has coordinates that correspond to the coordinate surfaces 211 and 212. In one embodiment, described in further detail below, the coordinate surfaces are able to sense the coordinates of the body fabric and panel on the coordinates surfaces 211 and 212, compare those coordinates with preprogrammed coordinates and communicate to an operator whether or not the actual coordinates match the preprogrammed coordinates.

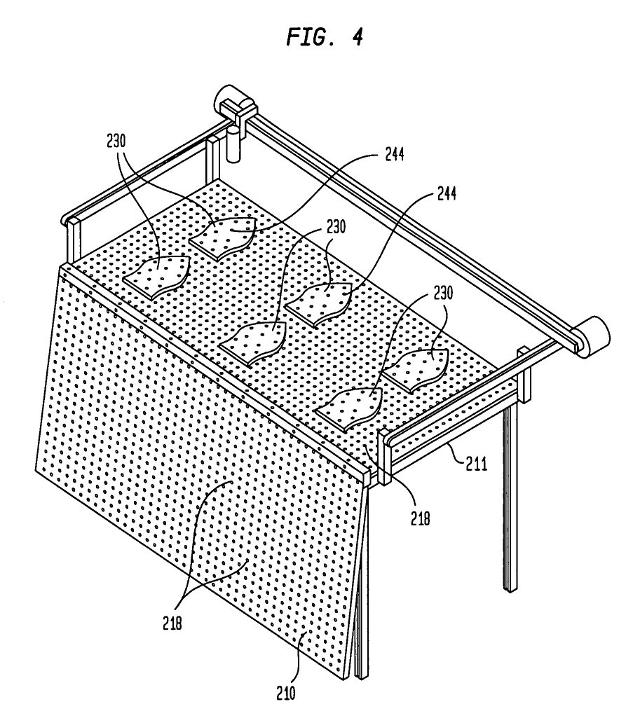

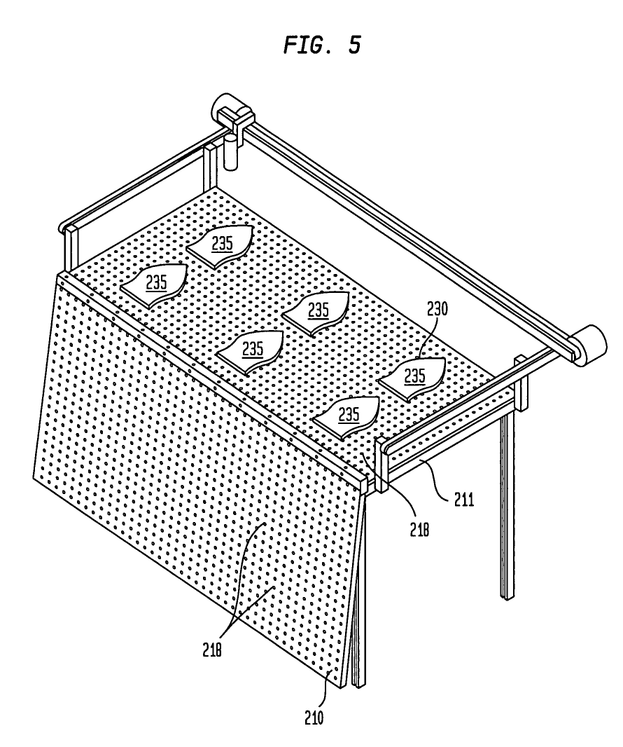

Referring to FIG. 4, a plurality of pallets 230 are placed on the first surface 211. These pallets are also perforated. The perforated pallets 230 are used as supports for fabric panels 235 (FIG. 5). The perforations in pallets 230 are provided so that the panels 235 will be retained on perforated pallets 230 when vacuum is drawn from the backside of the first surface through apertures 218. The vacuum force is also used to retain the pallets 230 on surface 211.

Note that, in FIG. 5, the fabric panels 235 have the same configuration as the perforated pallets 230. This is preferred but not required. One skilled in the art can manufacture perforated pallets of a variety of configurations and it is not absolutely necessary that those configurations conform exactly to the configuration of fabric panels 235. The pallets 230 are dimensioned such that the panels 235 extend slightly beyond the pallet perimeter. This relationship ensures that any excess adhesive is deposited on the coordinate surface 211 and not on the pallet 230. This prevents excess adhesive from contacting the body fabric during body fabric/panel assembly, which is not desired for reasons described in detail below.

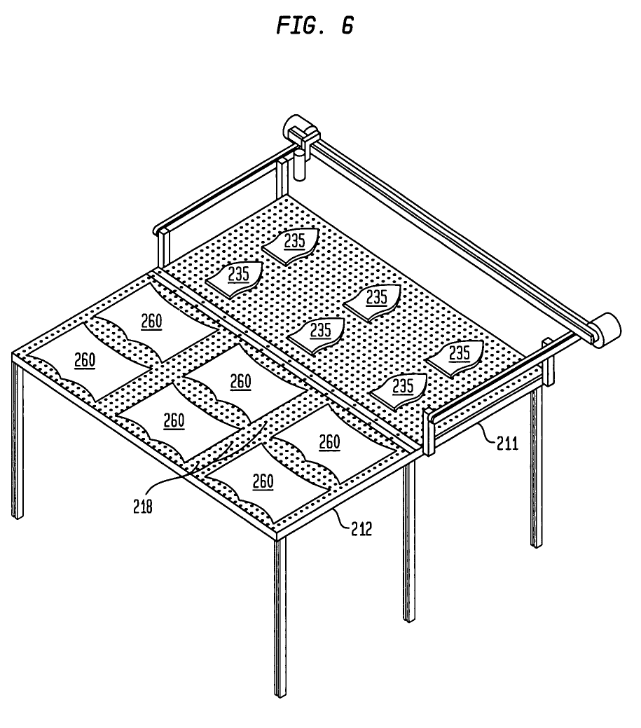

Referring to FIG. 6, coordinate surface 212 has been pivoted so that it is coplanar with coordinate surface 211. Surface 212 supports body fabric 260. As previously stated, coordinate surface 212 has apertures 218 so that a vacuum force can be drawn from coordinate surface 212 in order to retain body fabric panels 260 in place on surface 212. It is noted that, in one embodiment one or both of coordinate surfaces 211, 212 are flexible to compensate for any non-uniformities in fabric or pallet thickness when the two coordinate surfaces are pivoted into contact with each other.

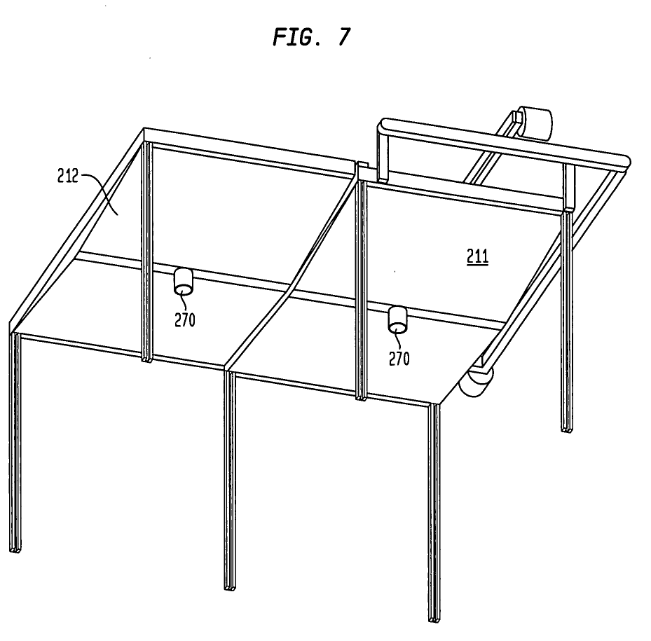

Referring to FIG. 7, the outlets 270 on the bottom on coordinate surfaces 211 and 212 are illustrated. These outlets are attached to a vacuum blower (not illustrated). As previously described, a vacuum blower draws air through the perforations in coordinate surfaces 211 and 212 (and the perforations in pallets 230) and then through outlets 270. The vacuum drawn by the blower fixes fabric panels 235 to coordinate surface 211 and the body fabric 260 to coordinate surface 212.

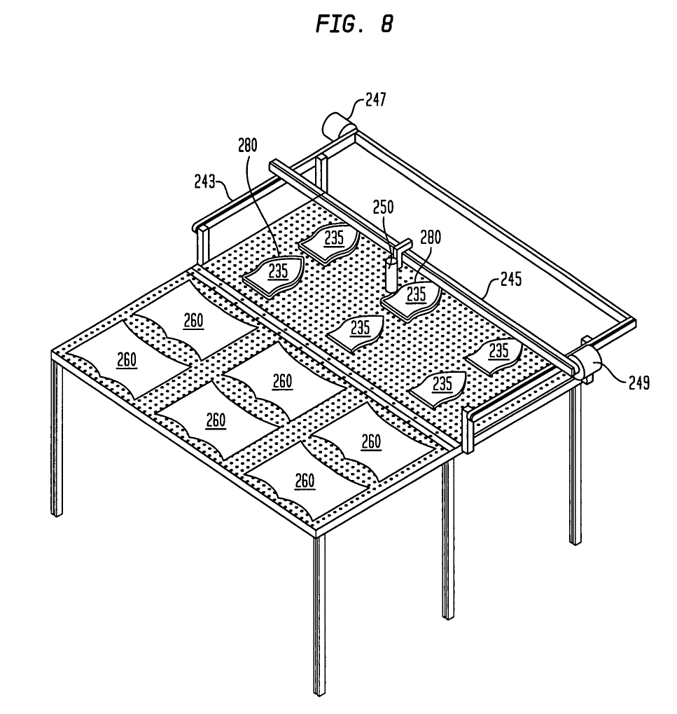

Referring to FIG. 8, the adhesive dispensing head 250 is moved to dispense adhesive 280 on fabric panels 235. As illustrated in FIG. 8, stepper 249 moves the adhesive dispensing head 250 along linear slide “x” axis 245. Meanwhile, stepper motor 247 moves the adhesive dispensing head 250 along linear slide “y” axis 243. This movement allows the adhesive dispensing head 250 to be positioned at virtually any location above surface 211. Although only one adhesive dispensing head is illustrated in the Figures, applicants contemplate embodiments in which multiple dispensing heads are used. For example, an array of dispensing heads that corresponds to the number of pallets in either the x or y direction is contemplated for use in the system so that adhesive can dispensed onto each panel in a single row or column simultaneously. Such an arrangement speeds the process along, rather than using a single dispensing head to dispense adhesive on every panel on the coordinate surface.

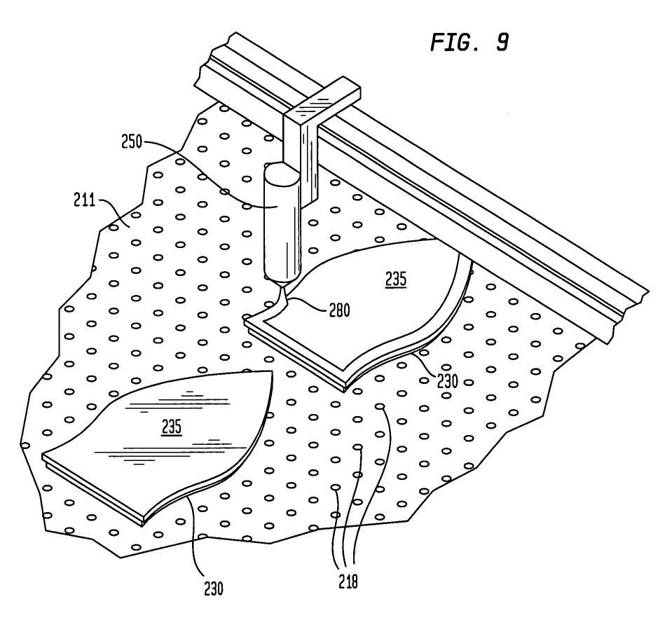

Referring to the detail view in FIG. 9, adhesive 280 is dispensed along the perimeter of fabric panel 235. The adhesive region 280 is the predetermined region of panel 235. As previously described, the predetermined region is the region identified for adhesive placement on panel 235. Note in FIG. 9 that the pallet 230 causes the fabric panel 235 to be raised above first coordinate surface 211.

Also note that the panel 235 extends beyond the pallet 230. This insures that any excess adhesive goes on the panel 235 or the coordinate surface 211. The purpose of this arrangement is to ensure that the only adhesive that contacts the body fabric is on the panel 235. Adhesive on the body fabric outside the perimeter of the panel is not desired because it detracts from the appearance of the garment, can cause discomfort to the wearer, adversely affect garment stretch, etc. In a preferred embodiment, the only adhesive that contacts the body fabric is the adhesive placed interior to the perimeter of the panel 230. In this embodiment any excess adhesive goes onto the coordinate surface 211. Due to the separation of surfaces 211 and 212 during panel assembly (attributed primarily to the thickness of the pallet 235) the excess adhesive deposited on the coordinate surface 211 is not likely to be transferred onto the body fabric 260 during panel/body fabric assembly.

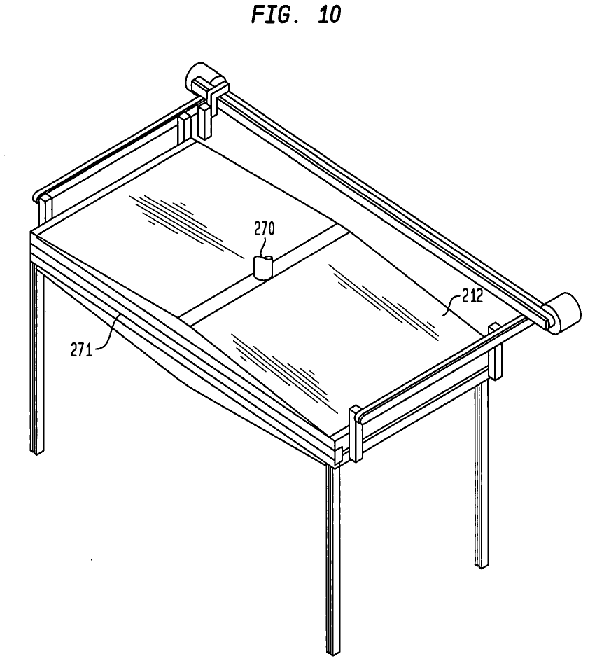

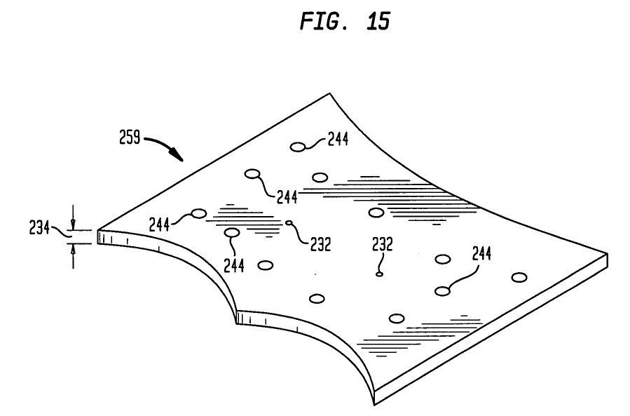

Referring to FIG. 10, after the adhesive 280 has been applied to the perimeter of the fabric panels 235 supported by coordinate surface 211, coordinate surface 212 is pivoted so that body fabric 260 is brought into contact with panels 235. Piano hinge 271 is provided so that coordinate surfaces 211 and 212 are as parallel as possible during body fabric/panel assembly despite being separated by the thickness of pallets 235 (and optional body fabric platform 259 described in FIG. 15). Although not illustrated in FIG. 10, vacuum force continues to be drawn through the bottom of coordinate surface 212 (through apertures 218 and through outlet 270). This ensures that body fabric 260 is retained in the proper place on coordinate surface 212 as it is inverted to bring body panels 260 into contact with fabric panels 235. Although not shown, slight pressure is applied to the coordinate surfaces 211, 212 to facilitate assembly of the body fabric and panel.

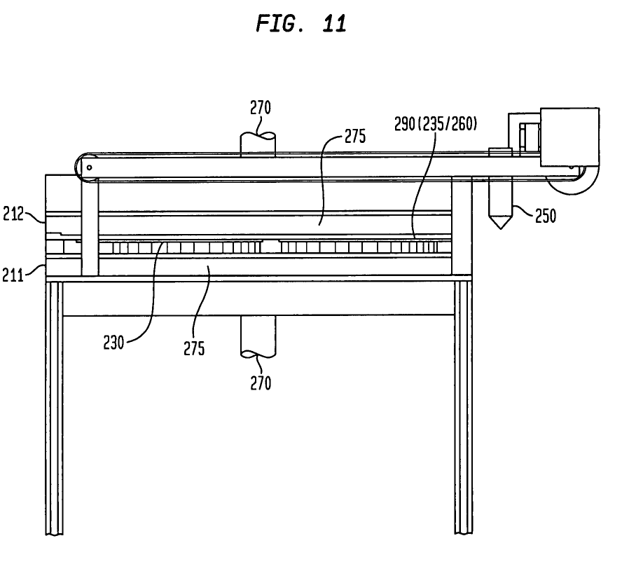

Referring to FIG. 11, in side view, surfaces 211 and 212 are shown as in folded over arrangement with pallets 230 and fabric assembly 290 (fabric assembly 290 is the fabric panel 235 fixed to body fabric 260) interposed therebetween. The adhesive 280 (not shown) binds fabric panel 235 to body fabric 260.

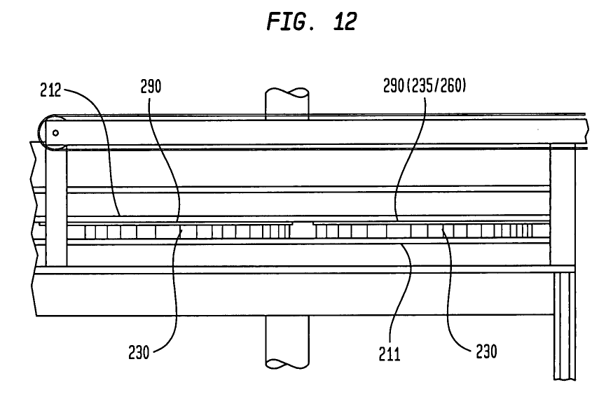

Referring to FIG. 12, pallets 230 are viewed in detail with fabric assembly 290 more clearly visible.

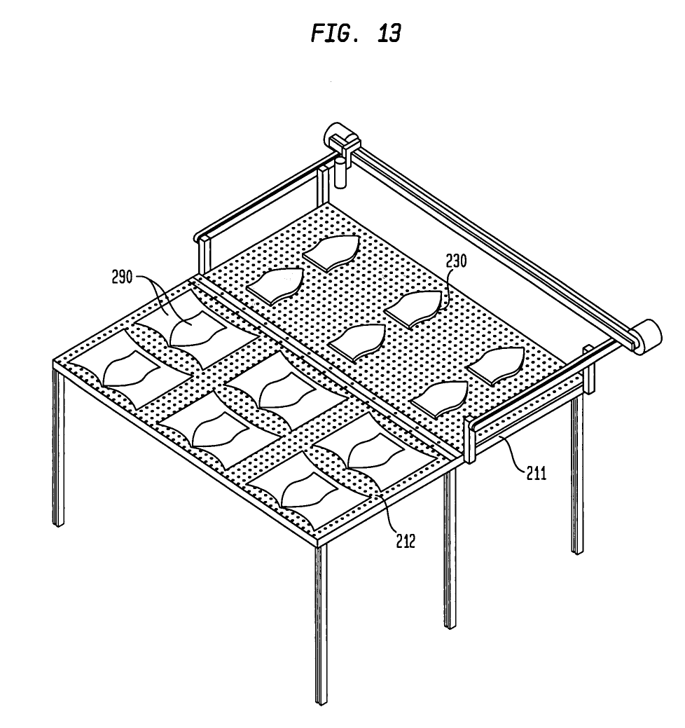

Referring to FIG. 13, after the body fabric 260 has been brought into contact with fabric panels 235; the vacuum force drawn from the bottom surface 211 is turned off. After this, surface 212 is pivoted away from surface 211. The vacuum force drawn from the bottom of surface 212 remains to ensure that fabric assemblies 290 are retained on surface 212 as it is pivoted away from surface 211. The fabric assemblies are then removed from surface 212 and cured.

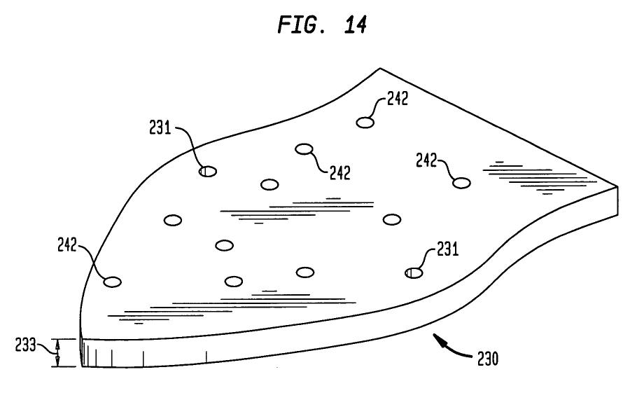

Referring to FIG. 14, the pallet 230 is illustrated with holes 231. These holes 231 have pins, which cooperate with the apertures, 118 in the coordinate surface to precisely place the pallet 230 at certain coordinates within the coordinate space. In an optional embodiment, the apertures 118 are equipped with sensors that communicate with the controller (not shown). Specifically, the sensors communicate the location of the pallet pins associated with the pallet holes 231 to the controller. In this embodiment, the coordinates of the pallet 230 are preprogrammed in the controller 241 (FIG. 3). The controller 241 compares the preprogrammed coordinates with the coordinates communicated by the sensor. If there is correspondence, the operator is allowed to proceed with the process without warning. If the coordinates communicated by the sensor do not correspond with the preprogrammed coordinates, the apparatus issues a warning to the operator or otherwise prevents the operator from proceeding with the process until the pallet is placed with the correct coordinates.

The pallet 230 had a thickness 233. This thickness, as previously explained, is to ensure that the panel is kept above the coordinate surface and, more importantly, the excess adhesive (if any) deposited on the coordinate surface 211. This, in turn, ensures that no excess adhesive will be transferred to the body fabric 260 during the assembly process.

The pallet 230 also has holes 242. The purpose of these holes is allow vacuum to be drawn from the backside of the pallet to fix the pallet 230 and the fabric placed thereon, to the coordinate surface.

Referring to FIG. 15, a body fabric platform 259 is illustrated in detail. The platform 259 has holes 232. These holes 232 have pins, which cooperate with the apertures, 118 in the coordinate surface to precisely place the platform 260 at certain coordinates within the coordinate space. The platform 259 has a thickness 234 that is typically thinner than pallet 230. The platform 259 can be thinner because the reason for the pallet thickness (i.e. keeping the panel fabric above any excess adhesive deposited on the coordinate surface) is not presented by the body fabric, since the adhesive is not directly applied to the body fabric. The body fabric platform 259 is also depicted as having holes designated 244. The purpose of these holes 244 is allow vacuum to be drawn from the backside of the pallet to fix the pallet 230 and the fabric placed thereon, to the coordinate surface (not shown).

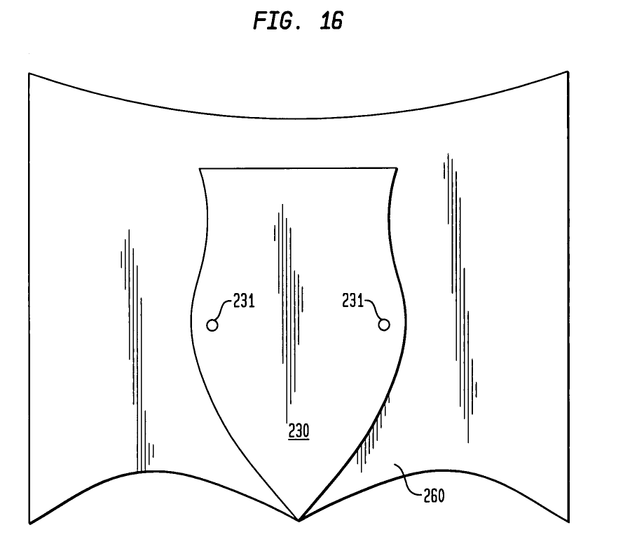

As illustrated in FIG. 16, the alignment holes 231 in the pallet line up with the holes 232 in the platform 260 to indicate the proper position of the body fabric relative to the position of the panel 235. While not required, it is advantageous if the spacing of holes 231 and 232 are identical. This will ensure proper alignment of the body fabric and panel when the two are brought together for assembly.

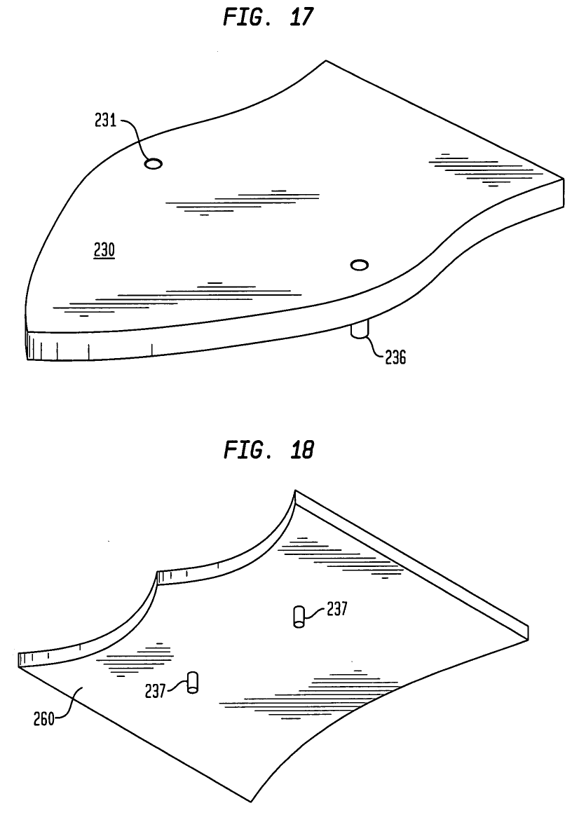

FIG. 17 illustrates the pins 236 used to fix the pallet 230 on the coordinate surface (not shown). Note that the pins 236 are spaced apart a fixed distance. The distance corresponds to the distance between to apertures in the coordinate surface, or some integer multiple of that distance. The purpose of the pins 236 is to fix the pallet 230 in position within the coordinate surface to allow for precision placement of the adhesive on the panel and precision alignment of the panel with the body fabric.

FIG. 18 illustrates the pins 237 in the bottom of the body fabric platform 259. Again, the pins permit precision placement of the platform 259 on the coordinate surface 212. Again, the pins are spaced apart a distance that corresponds to the distance between apertures in the coordinate surface 212, or some multiple of that distance.

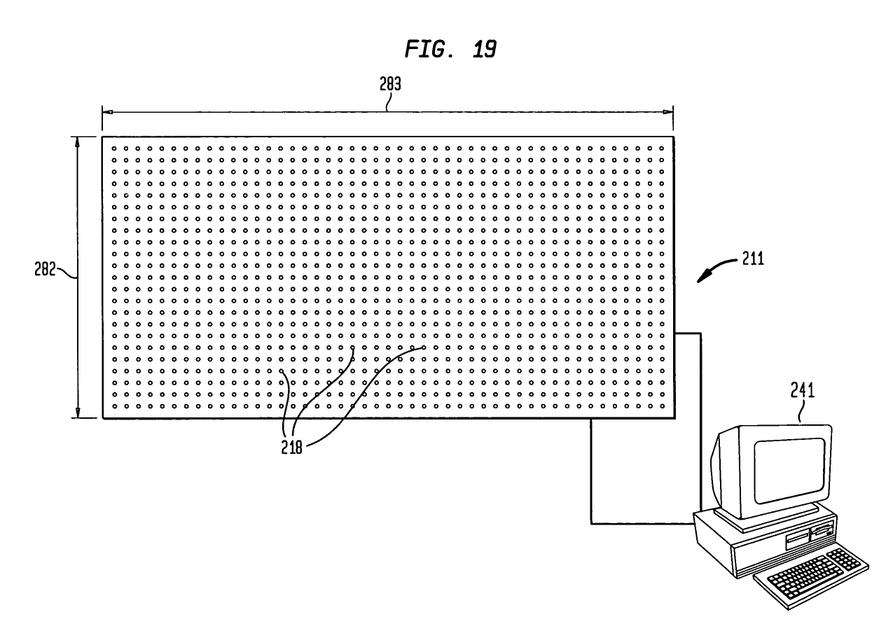

FIG. 19 illustrates the coordinate surface 211 with x axis and y axis designated. The apertures 218 define the coordinates in the surface 211. Each aperture is equipped with a sensor (not shown) that senses the aperture in which the pins of the pallet (not shown) are placed. The sensors communicate with the controller, illustrated as CPU 241. The coordinate in which the pallet pins are placed are communicated to CPU 241 which compares them with pre-programmed coordinates. As previously stated, if the actual coordinates correspond to the desired coordinates, the operator is allowed proceed with the process of applying adhesive to the panels and assembling the panels to the body fabric. If the actual coordinates do not correspond, then the operator is issued a warning or is not allowed to proceed with the process.

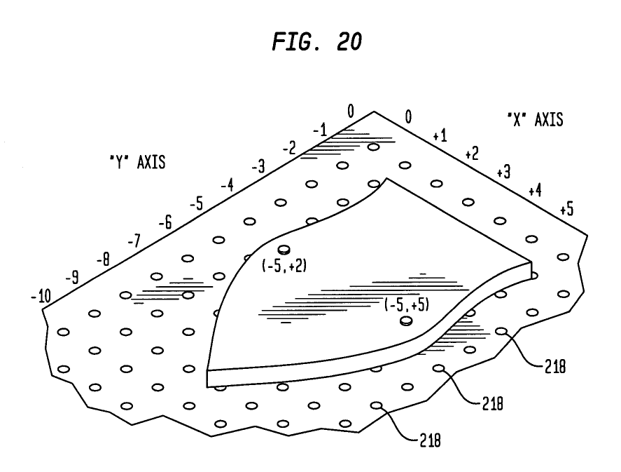

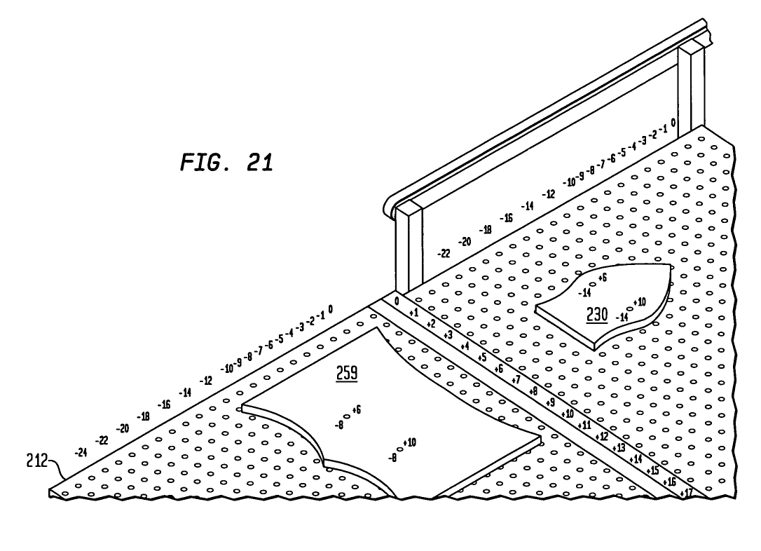

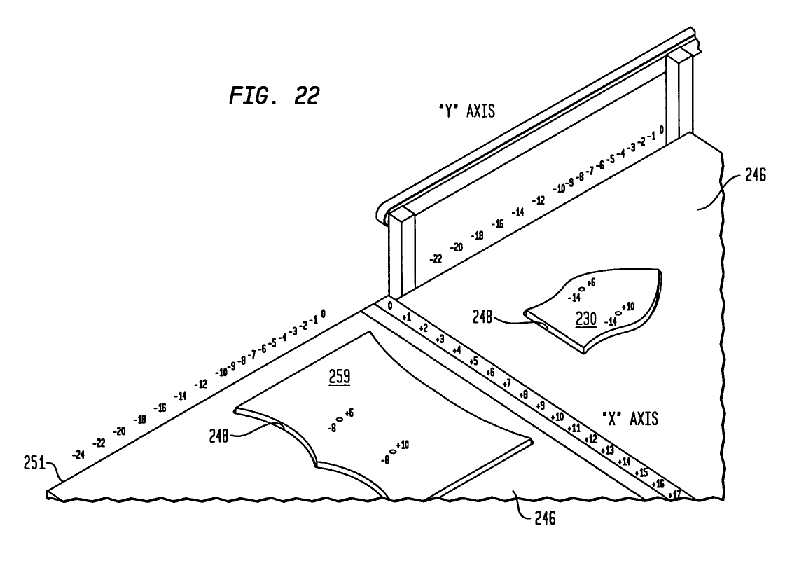

This embodiment is illustrated in greater detail in FIGS. 20 and 21. There the coordinate surface is illustrated as a grid of apertures 218. Each aperture is assigned a coordinate value on the x and y axis. The coordinates (y,x) assigned to the pins (not shown) of pallet 230 are (−5, +2) and (−5, +5). Based upon this information, the movement of the adhesive dispenser (not shown) can be controlled with precision relative to the pallet 230 (and panel). This allows dispensing the adhesive at the desired location on the panel. FIG. 21 expands the view to illustrate both coordinate surfaces 211 and 212. The coordinates (x,y) of the pallet 230 pins are (+6, −14), (+10, −14). The coordinates of the platform 259 are (+6, −8), (+10, −8).

In yet another embodiment illustrated in FIG. 22 the coordinate surface is provided by a precision cut paper template 246. In this embodiment a precision cutting apparatus (e.g. a Gerber cutting tool) is used to create a template for placement of the body fabric and panels on their respective coordinate surfaces. Cut outs 248 are made in the paper 246 for precision placement of the pallet 230 on which the panels are placed and platform 259 on which the body fabric is placed. The software for the Gerber cutting tool is used to define the cutout regions in the paper 246 and to guide the cutting tool to precisely cut out these regions. The cut outs 248 facilitate the precision placement of the pallets 230 and platforms 259 on the coordinate surface with the need for an alignment grid of holes and sensors that indicate that the desired alignment has been achieved. The paper 246 with the cutouts 248 is then placed on the respective supporting surfaces. This embodiment also has the advantage of providing a disposable covering for the supporting surface on which the panels are placed to receive the glue. After the adhesive is deposited and the panels are removed, the paper with any adhesive residue thereon is removed and discarded, facilitating clean up.

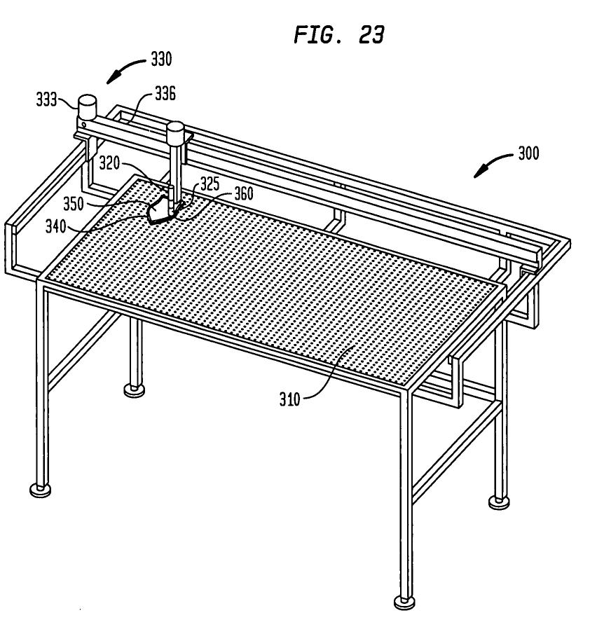

Referring to FIG. 23 another embodiment of the present invention is illustrated. This embodiment differs from other embodiments in that, in this embodiment, a roller coater is used to dispense adhesive onto the predetermined perimeter region of the panel. Illustrated is apparatus 300 with coordinate surface 310 and adhesive dispensing head 320. Adhesive dispensing head 320 has roller dispenser 325. Adhesive dispensing head is attached to positioning mechanism 330 which has stepper motors in both the “x” direction (333) and “y” directions (336). The operation of the stepper motors and associated structure to adjust the position of the dispensing head with respect to the coordinate surface has been described in the context of previous embodiments and is not discussed in detail with regard to this embodiment.

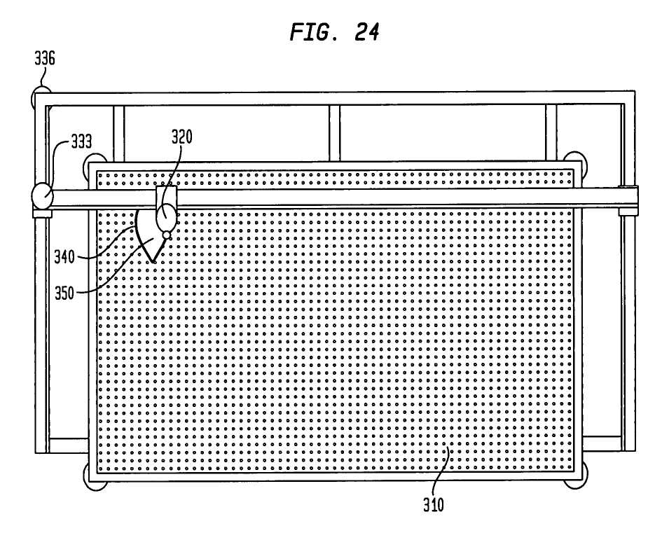

Referring to FIG. 24, the dispensing head 320 with roller dispenser 325 is seen to distribute a uniform ribbon of adhesive 340 on the perimeter of panel fabric 350 disposed on pallet 360. Pallet 360 is precision placed on coordinate surface 310 as previously described.

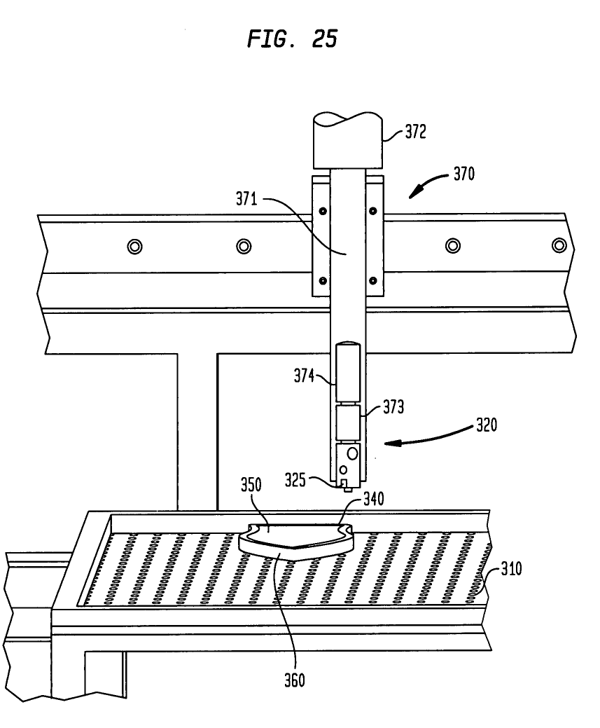

Referring to FIG. 25, additional detail of the dispensing head 320 is illustrated. Specifically, dispensing head 320 is attached to support 371 that forms part of the mechanism 370 used to adjust the distance between dispensing head 320 and coordinate surface 310. The mechanism 370 also has a stepper motor 372 that controls and adjusts the position of the dispensing head relative to the coordinate surface. The dispensing head 320 has roller mechanism 325 used to dispense adhesive 340 onto the fabric panel 350. The dispensing head is also equipped with bearing 373 and rotation stepper motor 374. Stepper 374 allows rotation of the dispensing head 370 to permit roller 372 to follow the contours of the perimeter of the fabric panel 350.

Dispensing head 320 is connected to a reservoir for adhesive. The connection is not illustrated, but such connections are well within the common knowledge of one skilled in the art and need not be illustrated herein. The dispensing head has an internal reservoir or chamber (not shown) which holds an adequate reserve of adhesive to ensure that the roller dispenser 325 is adequately wetted with adhesive during application of the adhesive onto the fabric panel 350. The roller dispenser can optionally be equipped with a retractable knife (not shown). The retractable knife is used to remove excess adhesive from the roller to ensure uniform adhesive deposition. An example of such a retractable knife for use with a roller coated is described in commonly-owned patent application entitled “ADHESIVE SEAM AND METHOD AND APPARATUS FOR ITS MANUFACTURE” having U.S. Ser. No. 11/500,639 (Publication No. US-2007-0084390-A1, filed on Aug. 8, 2006, which is incorporated by reference herein.

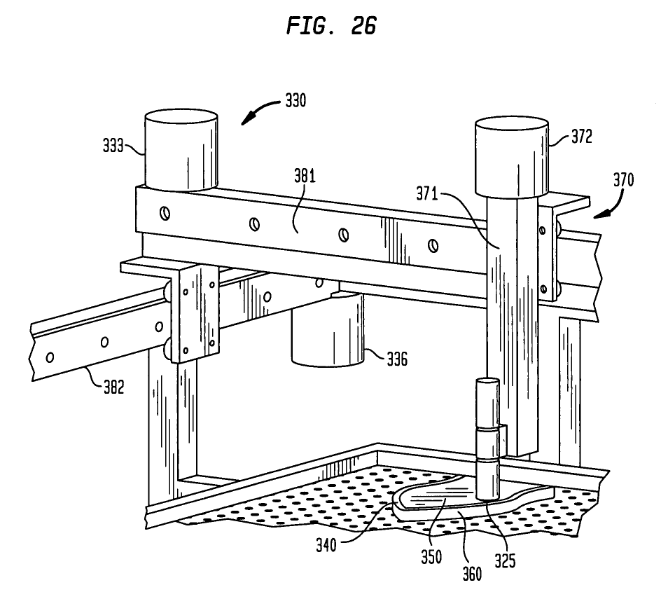

FIG. 26 illustrates additional detail of the mechanism 370 as well as the mechanism 380 that is used to position the dispensing head at the desired x and y coordinates relative to the coordinate surface. Specifically, mechanism 330 has two tracks, 381 (“x” axis) and 382 (“y” axis) that stepper motors 333 and 336 use to position dispensing head 320 in the desired x, y position relative to the coordinate surface 310. The manner in which the stepper motors are used to position adhesive dispensing head 320 is described elsewhere in detail herein. Previously described stepper motor 372 (that controls and adjusts the position of the dispensing head relative to the coordinate surface), bearing 373 and rotation stepper motor 374 (that control the rotation of the dispensing head 360) are also illustrated.

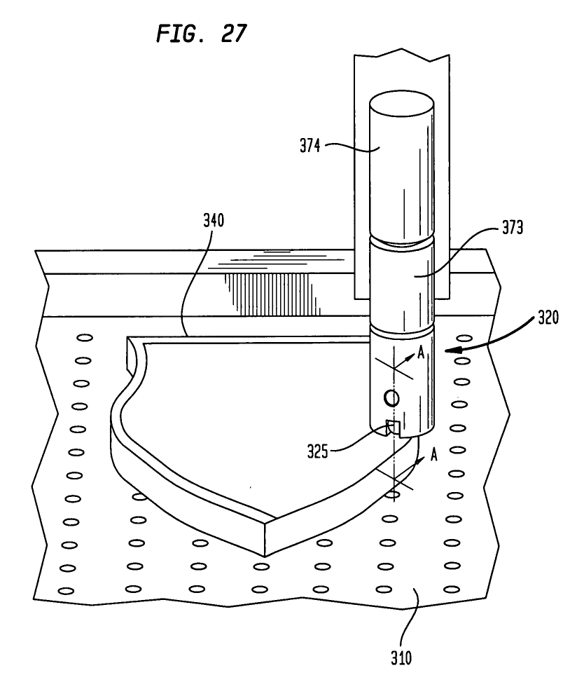

Referring to FIG. 27, there is illustrated the dispensing head 320 with roller mechanism 325. Because the dispensing head 320 is configured to rotate, the ribbon of adhesive 340 follows the contour of the panel 350 on which the adhesive is placed.

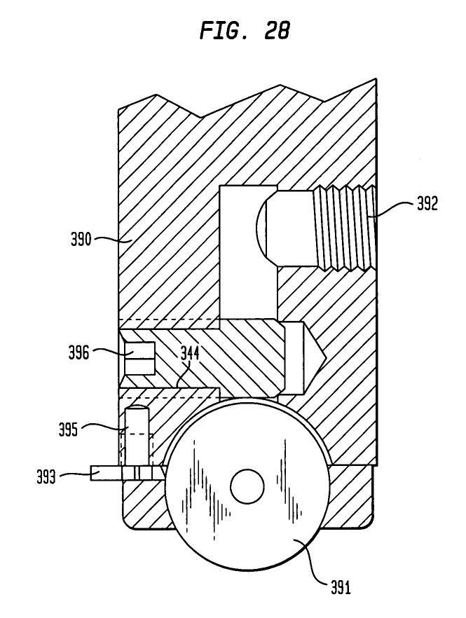

A cut-away view of the roller mechanism 325 is illustrated in FIG. 28. The roller mechanism has a body 390 in which the roller wheel 391 is rotatably disposed. Note that a portion of the roller wheel 391 extends below the bottom portion of the body 390. Adhesive enters the roller mechanism 325 through inlet 392 which is in fluid communication with adhesive reservoir 395. Note that adhesive reservoir is partially open to the wheel 391. This permits the adhesive to wet the wheel surface as the wheel rotates beneath the reservoir 395.

The reservoir 395 is also equipped with a level sensor 396 that detects the level of the adhesive in the reservoir. The sensor 396 outputs a signal that indicates the amount of adhesive in the reservoir. This information is communicated to a controller that controls the output of the adhesive from the adhesive dispenser (not shown). Specifically, when the level of adhesive is below a certain level, adhesive is allowed to flow from the dispenser into the roller mechanism 325. If the amount of adhesive is above a predetermined level, then the dispenser ceases to output adhesive into the roller mechanism.

Roller mechanism 325 is also equipped with a knife 393 for removing excess adhesive from the roller 391. As illustrated, the knife 393 is provided with knife adjustment 394 which allow the knife to be positioned laterally with respect to the wheel 391. The purpose is for the knife 393 to remove excess adhesive from the roller 391. As noted above, the excess adhesive is removed to provide for uniform adhesive deposition by the roller onto the panel (not shown).

Although the invention herein has been described with reference to particular embodiments, it is to be understood that these embodiments are merely illustrative of the principles and applications of the present invention. It is therefore to be understood that numerous modifications, additions and substitutions may be made to the illustrative embodiments without departing from the scope and spirit of the invention or that other arrangements may be devised without departing from the spirit and scope of the present invention.

What is claimed:

1. A method for forming a garment comprising:
providing a fabric panel configured to be attached to a body fabric, the fabric panel having a perimeter and a perimeter region, the perimeter region being the portion of the panel surface adjacent the panel perimeter;
identifying an adhesive region on the panel, the adhesive region being at least partially coextensive with the perimeter region;
applying liquid adhesive onto the adhesive region;
applying the panel on a predetermined location of a body fabric such that the adhesive region contacts the body fabric; and
curing the adhesive to create the garment.

2. The method of claim 1 wherein at least one of the panel and body fabric are formed from elastic fibers and wherein the adhesive does not substantially affect the elasticity of the elastic fibers.

3. The method of claim 1 wherein the predetermined region defines an area on the panel surface and that area is less than half of the panel surface area.

4. The method of claim 1 wherein the fabric panels are made of a material selected from the group consisting of natural fibers, synthetic materials and blends of natural fibers and synthetic materials.

5. The method of claim 4 where in the synthetic fibers are selected from the group consisting of polyester, rayon, polyurethane foam, spandex and nylon.

6. The method of claim 4 wherein the natural fibers are selected from the group consisting of cotton and wool.

7. The method of claim 1 wherein the liquid adhesive is selected from the group consisting of thermosetting adhesive, thermoplastic adhesive and radiation-curable adhesive.

8. The method of claim 1 wherein the adhesive is at least partially cured by exposing the adhesive to moist ambient air.

9. The method of claim 1 wherein the fabric panels are finished and further comprising the step of selecting an adhesive that adheres to the fabric panels with the finish thereon.

10. The method of claim 9 wherein the finish and adhesive are both water-based.

11. The method of claim 9 wherein the finish and adhesive are both hydrophobic.

12. The method of claim 1 further comprising cutting the fabric to form the panels.

13. The method of claim 12 wherein the step of cutting is an automated cutting step selected from the group consisting of Gerber cutting, die cutting, sonic cutting, hydro cutting and laser cutting.

14. The method of claim 1 wherein the adhesive is applied to the interface region by one of either spray coating, nozzle coating, roller coating or combinations thereof.

15. The method of claim 1 wherein the liquid adhesive is stored in an inert atmosphere prior to applying the adhesive to the material strip.

16. The method of claim 15 wherein the inert atmosphere is selected from the group consisting of nitrogen, argon and super-dried air.

17. The method of claim 1 wherein the liquid adhesive is stored under vacuum.

18. The method of claim 1 wherein the uncured liquid adhesive is applied at a temperature in the range of about 200° F. to about 280° F.

19. The method of claim 18 wherein the uncured liquid adhesive is applied at a temperature in the range of about 200° F. to about 260° F.

20. The method of claim 8 wherein the moist ambient air has at least about forty percent relative humidity.

21. The method of claim 14 wherein the adhesive applied onto the fabric panel has a thickness that is less than the thickness of the panel.

22. The method of claim 1 wherein the fabric panel has a first color and the adhesive, when cured, has a color that substantially matches the color of the fabric panel.

23. A system for assembling a panel to a body fabric, the system comprising:
a first coordinate surface for supporting and placing a panel fabric;
a second coordinate surface for supporting and placing a body fabric thereon;
an adhesive dispenser comprising a dispensing head and a positioner for placing the dispensing head relative to the first coordinate surface; and
a controller for controlling the positioner in response to a position sensor.

24. The system of claim 23 wherein the first coordinate surface and second coordinate surface further comprise a plurality of apertures.

25. The system of claim 24 wherein the apertures are coextensive with at least a portion of the coordinates in the coordinate surface.

26. The system of claim 23 wherein the dispenser comprises a nozzle.

27. The system of claim 26 wherein the dispenser further comprises a roller coater.

28. The system of claim 26 wherein the nozzle is selected from the group consisting of a slot nozzle and a spray nozzle.

29. The system of claim 23 wherein the positioner comprises a first track corresponding to a first axis relative to the coordinate surface and the second track corresponding to a second axis relative to the coordinate surface and a first motor for moving the dispensing head along the x axis and a second motor for moving the dispensing head along the y axis.

30. The system of claim 29 wherein the dispensing head is adjustably attached to the positioner to permit adjustment to the direction from which the dispensing head dispenses adhesive.

31. The system of claim 29 wherein the controller positions the dispensing head along the x and y axis in response to the coordinates of the panel on the coordinate surface.

32. The system of claim 25 wherein the coordinate surfaces further comprise an attachment mechanism for removably placing the body fabric or panel fabric thereon.

33. The system of claim 32 wherein the attachment mechanism is a vacuum system that drawing a vacuum through the apertures, thereby removably affixing the body fabric or panel fabric on its respective coordinate surface.

34. The system of claim 23 wherein the adhesive dispenser is in fluid communication with an adhesive reservoir.

35. The system of claim 34 wherein the reservoir stores adhesive in an inert atmosphere.

36. The system of claim 34 wherein the reservoir stores the adhesive under vacuum.

37. The system of claim 25 further comprising a moveable panel pallet.

38. The system of claim 37 wherein the pallet comprises at least two pins adapted to be received by the apertures in the first coordinate surface.

39. The system of claim 37 wherein the pallet comprises a plurality of apertures.

40. The system of claim 37 wherein the movable panel pallet has a perimeter that is substantially entirely within the perimeter of the panel.

41. The system of claim 25 further comprising a moveable body fabric platform.

42. The system of claim 41 wherein the moveable body fabric platform further comprises at least two pins adapted to be received by the apertures in the second coordinate surface.

43. The system of claim 37 wherein the panel, when placed on the pallet is raised above the first coordinate surface.

44. The system of claim 23 wherein the first coordinate surface and the second coordinate surface are capable of relative movement to bring the panel supported by the first coordinate surface into contact with the body fabric supported by the second coordinate surface.

45. The system of claim 44 wherein the first coordinate surface and the second coordinate surface are in hinged attachment.

46. The system of claim 23 wherein the first coordinate surface has a template thereon with a cut out configured to receive the panel fabric.

47. The system of claim 46 wherein the second coordinate surface has a template thereon with a cut out configured to receive the body fabric.

48. A system for assembling a panel to a body fabric, the system comprising:
a first coordinate surface for supporting and placing a panel fabric;
a second coordinate surface for supporting and placing a body fabric thereon;
an adhesive dispenser means comprising a dispensing head and a position means for placing the dispensing head relative to the first coordinate surface; and
a control means for controlling the positioning means in response to a position sensor.

49. The system of claim 48 wherein the adhesive dispenser comprises a nozzle.

50. The system of claim 49 wherein the adhesive dispenser further comprises a roller coater.

51. The system of claim 48 wherein the nozzle is selected from the group consisting of a slot nozzle and a spray nozzle.

52. The system of claim 48 wherein the position means comprises a first track corresponding to a first axis relative to the coordinate surface and the second track corresponding to a second axis relative to the coordinate surface and a first motor for moving the dispensing head along the x axis and a second motor for moving the dispensing head along the y axis.

53. The system of claim 52 wherein the position of the dispensing head is adjustable to control the direction from which the dispensing head dispenses adhesive.

54. The system of claim 52 wherein the controller positions the dispensing head along the x and y axis in response to the coordinates of the panel on the coordinate surface.

55. The system of claim 48 wherein at least one of the first and second coordinate surfaces have a retaining means for retaining one of the panel or body fabric on its respective coordinate surfaces.

56. The system of claim 55 wherein the retaining means is a vacuum system that cooperates with a plurality of apertures in the at least one coordinate surface to retain the one of the panel or body fabric on the coordinate surface.

57. A garment comprising a first fabric having a first surface to which a second fabric having a second surface is adhesively attached, wherein the adhesive is in a defined region in relation to a perimeter of the second fabric surface, that defined region being interior to the perimeter of the fabric, the defined region being less than the entire area of the second fabric surface.

58. The garment of claim 57 wherein the first fabric is a body fabric and the second fabric is a panel fabric.

59. The garment of claim 58 wherein at least one of the panel and body fabric are formed from elastic fibers and wherein the adhesive does not substantially affect the elasticity of the elastic fibers.

60. The garment of claim 59 wherein the defined region is less than fifty percent of entire area of the second fabric surface.

61. The garment of claim 57 wherein the garment is selected from the group consisting of foundation garments and active wear.

62. The garment of claim 61 wherein the foundation garment is a bra.

63. The garment of claim 61 wherein the active wear is swimwear.

64. The garment of claim 57 wherein the garment comprises one or more seams and the panel is not adjacent to the one or more seams.
